(19) United States
(12) Patent Application Publication
(10) Pub. No.: US 2023/0306375 A1
(43) Pub. Date: Sep. 28, 2023

(54) AUTOMATIC NOTIFICATION GENERATION

(71) Applicant: Avaya Management L.P., Durham, NC (US)

(72) Inventor: Ananda H P, Pune (IN)

(21) Appl. No.: 17/703,131

(22) Filed: Mar. 24, 2022

(51) Int. Cl. G06Q 10/10; G06F 3/0482

(52) U.S. Cl. CPC G06Q 10/1095; G06F 3/0482

(57) ABSTRACT

Recurring events, such as meetings, are often created with a finite number of recurring iterations. The number of iterations is often only a guess and may include superfluous iterations, and in doing so allocate resources that cannot be use for another purpose. In other cases, two few iterations are initially selected, which often go unnoticed until the time for the next, but absent, iteration of the event has occurred. By automatically generating a prompt or automatically creating additional iterations, an event may be created with a number of iterations and a timely prompt provided to determine if the event should be extended and, if so, extending the event.

### FIELD OF THE DISCLOSURE

The invention relates generally to systems and methods for the automatic generation of messages and particularly to flag the conclusion of a series of events.

### BACKGROUND

When scheduling an event, such as meeting, there is often an option to make such event a series, recurring at regular intervals, such as every week or month. When an event is known to be recurring, a user scheduling the event must speculate how many iterations will be sufficient. Scheduling an event is often tied to reserving conference rooms, networking equipment, etc. If the user sets the recurring event at too many iterations, such resources won't be available to be utilized for other purposes. If the user sets the recurring event at too few iterations, such error may not be realized until it is too late, at which point the user may have to attempt rescheduling such event. For example, a recurring event, such as a meeting, may be set to recur for ten instances and then ceases. However, it is often at or past the time for a subsequent iteration of the meeting to take place before the participants realize additional meeting iterations are required. Adding more iterations of the meeting, or recreating a new series of meetings, may not be straightforward as the absence of subsequent iterations may have allowed meeting resources to be allocated for other purposes during the time of the next iteration. As a result, event organizers and participants may be forced to delay the meeting, which may impact other resources, such as those that are often more system-resource and/or cost intensive, in order to schedule and then conduct the next iteration of the meeting.

### SUMMARY

These and other needs are addressed by the various embodiments and configurations of the present invention. The present invention can provide a number of advantages depending on the particular configuration. These and other advantages will be apparent from the disclosure of the invention(s) contained herein.

As an introduction, and in one embodiment, a reminder message is generated and presented in advance of a series of events ending. In another embodiment, the message presents options, such as to solicit an input that would extend the series or to dismiss the notification.

In another embodiment, when a series of events is created, a graphical element is provided, such as a prompt asking, “End of Series Notification? Yes/No.” When selected, a user can then accept the default timing for the notification or override the default and provide their own timing for the notification.

At the designated time, often at the last or second to last occurrence of the series, the notification is generated and presented to the scheduler, such as a prompt asking, “Do you want extend the meeting? Yes/No”. If the user selects “yes”, the meeting will then be extended by a default number of iterations/end date or the user can override the default setting and provide their own number of iterations/end date. Optionally, an end-of-series reminder message can again be generated and presented in advance of the extended series ending.

In one embodiment, a method of modifying a calendar event record is disclosed, comprising: accessing a calendaring database comprising a calendar and wherein the calendar comprises a record of an event and wherein the event comprising a series of recurring iterations of the event; determining whether the event has reached a conclusion notification threshold; upon determining that the event has reached the conclusion notification threshold, generating a prompt to extend the event with a number of additional iterations; causing a user device to present the prompt and receive a response therefrom; and when the response indicates extending the series, generating a meeting event to add the number of additional iterations to the event.

In another embodiment, a system is disclosed, comprising: a database comprising calendar records for at least one user, the calendar record comprising an event and wherein the event comprising a series of recurring iterations of the event; a processor configured with instructions maintained in a non-transitory memory, to cause the processor to perform: accessing the calendaring database comprising the calendar; determining whether the event has reached a conclusion notification threshold; upon determining that the event has reached the conclusion notification threshold, generating a prompt to extend the event with a number of additional iterations; causing a user device to present the prompt and receive a response therefrom; and
when the response indicates extending the series, generating a meeting event to add the number of additional iterations to the event.

In another embodiment, a system is disclosed, comprising: means to access a calendaring database comprising a calendar and wherein the calendar comprises a record of an event and wherein the event comprising a series of recurring iterations of the event; means to determine whether the event has reached a conclusion notification threshold; means to, upon determining that the event has reached the conclusion notification threshold, generate a prompt to extend the event with a number of additional iterations; means to cause a user device to present the prompt and receive a response therefrom; and means to, when the response indicates extending the series, generate a meeting event to add the number of additional iterations to the event.

A system on a chip (SoC) including any one or more of the above aspects of the embodiments described herein.

One or more means for performing any one or more of the above aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system generated graphical element in accordance with embodiments of the present disclosure;

FIG. 3 depicts a system generated graphical element in accordance with embodiments of the present disclosure;

FIG. 4 depicts a process in accordance with embodiments of the present disclosure; and

FIG. 5 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

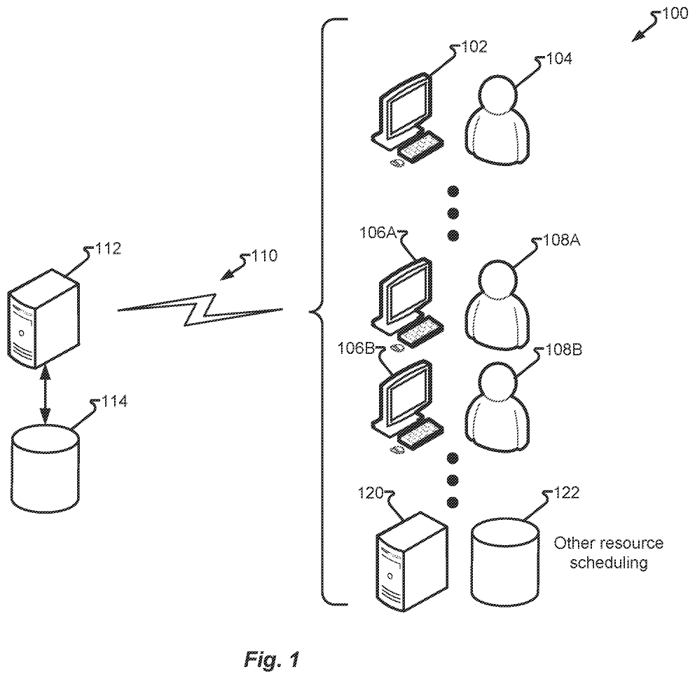

FIG. 1 depicts system 100 in accordance with embodiments of the present disclosure. In one embodiment, system 100 illustrates user device 102 utilized by user 104 to manage a calendar. The calendar may be embodied as a number of records in calendar database 114. The calendaring application may be embodied as a series of instructions maintained in a non-transitory data storage that cause a processor to perform the steps of the instructions. Accordingly, and in one embodiment, calendar server 112 and calendar database 114 may be embodied as a portion of user device 102. In another embodiment, one or both of calendar server 112 and/or calendar database 114 may be remotely located from user device 102 and accessed via communication link 110. Communication link 110 may comprise one or more of a public network (e.g., Internet) or private network (e.g., ethernet, WiFi, cellular data, Bluetooth, etc.).

In another embodiment, other users (human), such as additional user 108A-B may have their own calendars, which may be presented and optionally maintained on their respective devices additional user's device 106A-B, which may also include records in calendar database 114 operated by calendar server 112 and accessed via communication link 110. In yet another embodiment, other resources, such as conferencing equipment (e.g., recording server, automated translation agent, automated transcription agent, audio/video networking equipment, sufficient bandwidth for video, allocation of sufficient ports/addresses, etc.) or facilities (e.g., conference rooms, white boards, locations, etc.) may similarly have a calendar account comprising records in calendar database 114 and operated by calendar database 114. In another embodiment, resources (e.g., conferencing equipment, facilities, etc.) may have a discrete calendaring system, such as other resource scheduling device 110 and other resource calendar database 112, to maintain calendar records and updates thereto. For example, a conference room comprising video equipment may be scheduled by sending an invitation to the conference room, which is received by other resource scheduling device 110, and if the records maintained in other resource calendar database 112 indicate the requestor has authorization and the conference room is available, the conference room accepts the invitation and allocates the conference room via a process executing on other resource scheduling device 110. In another embodiment, scheduling the conference room may be conducted via sending an invitation to the conference room which is received by a process of calendar server 112 accessing calendar records in calendar database 114.

It is commonplace for calendar events, such as meetings, to be created with two or more recurring iterations of the meeting. As a result, the meeting is scheduled to take place a number of times having a particular pattern, such as a particular location and day/time of the week, month, quarter, year, etc. Similarly, the meeting includes the same invitees, whether they are human (e.g., additional user 108A, additional user 108B, etc.) and/or non-human (e.g., equipment, facilities, etc.). While some recurring meetings have an indefinite number of iterations, such as an enterprise has a yearly all-hands meeting that is planned to continue indefinitely, other meetings may not be indefinite and only require one or a few more iterations, such as to accomplish one particular task that will, at some point, end.

Unfortunately, it is also commonplace for the number of iterations to be based solely on speculation, which is often wrong. As a result, a scheduler may choose too many or too few iterations. If the scheduler chooses too many iterations, resources may be allocated for iterations of the meeting that are never attended and, often enough, never canceled. As a result, such resources are unavailable to be allocated for other purposes and remain unused. Conversely, if the chosen number of iterations is too few, the meetings will commence to the end of the series where the meeting ends, to the participants, unexpectedly and usually unknowingly. Often a participant identifies an issue that needs to be addressed at the next meeting, only to discover that there are no further iterations of the meeting scheduled. This often results in a scramble to reschedule the meeting. Rescheduling may be difficult as the attendees and/or other resources may now be allocated to other activities and are no longer available during the time/day the meetings previously took place.

In one embodiment, a triggering event occurs, such as the completion of a previously determined number of iterations (i.e., last in the series, penultimate in the series, etc.). In response to the triggering event, a reminder is provided to the meeting scheduler and/or other attendees, or those responsible for scheduling events for other individuals (e.g., administrators, facilities management, equipment management, etc.). The determination of the triggering event may be in response to a manual input or an automatic input determined without human intervention, such as a default setting. For example, with a relatively short series of iterations, there is a likelihood that the meeting organizer may miscalculate the number of actual meetings necessary by one or two iterations. As a result, a series, such as one initially created for three to ten iterations, may automatically generate a reminder that is triggered at onset the last meeting. For a longer series of meetings, such as weekly meetings set for a single year, the number of iterations necessary may actually be too many. As a result, a longer series may initiate reminders sooner, such as at the second, third, or fourth to last iteration. Optionally, the determination of when to trigger an event may occur in response to providing a record of the meeting and/or individual iterations, to an artificial intelligent system trained to determine the extension, such as a neural network.

A neural network, as is known in the art and in one embodiment, self-configures layers of logical nodes having an input and an output. If an output is below a self-determined threshold level, the output is omitted (i.e., the inputs are within the inactive response portion of a scale and provide no output). If an output is above the self-determined threshold level, an output is provided (i.e., the inputs are within the active response portion of a scale and provide an output). The particular placement of the active and inactive delineations is provided as a training step or steps. Multiple inputs into a node produce a multi-dimensional plane (e.g., hyperplane) to delineate a combination of inputs that are active or inactive.

A neural network may be trained by collecting a set of meetings comprising two or more iterations. Additionally, one or more attributes of the meetings may be collected to create a training set, such as to comprise one or more of the attributes of the attendees (e.g., title, role, department, projects assigned, etc.), resources, identified subject, communication type (e.g., in person, auto-only call, audio video call, mixture thereof, etc.), number of initial iterations, number of additional iterations added if any, whether or not the meetings were extended beyond their original listing or canceled before the series ended. One or more transformations are then applied to the meeting attributes comprising changing one or more attendees and/or attendee attribute, resource, subject, communication type, and number of iterations, in order to create a modified training set determined to not impact the number of additional iterations. Training the neural network in a first training stage comprising the training set and the modified training set. Creating a second training set for a second training stage comprising the first training the modified training set incorrectly determined as affecting the number of additional iterations required and then training the neural network in the second training stage. After being trained, the neural network may be provided with a record describing a newly created meeting with two or more iterations and determine therefrom the likelihood of a need for an extension and, optionally, the number of extensions that may be needed. In one embodiment, the number of extensions may then be automatically added to the series, and optionally identified to be automatically created, in response to the initial series ending and/or the determination of when to prompt a user to choose whether additional iterations are required.

End of series reminders may be included in a meeting notification reminder and/or other means (e.g., time-triggered email, text message, changing of an icon on a calendar application, etc.). If the attendees and/or resources are not available during one or more of the additional iterations that were added in order to extend the series, the meeting organizer may be given the option to continue as planned, knowing that some people and/or resources may not be available, or to dismiss the reminder and create a new series at a time when the necessary people and/or resources are available. As a further option, the meeting series may automatically be extended upon the occurrence of a particular triggering event (e.g., the meeting's last, second to last, etc., iteration) without human input, which may optionally have an identifier (i.e., “Weekly Staff Meeting (Additional iterations automatically generated. Cancel if not needed)”). As a further option, the choice to vote may be presented to the attendees with indicia of their selection and optionally indicia of their availability (e.g., “User A—Votes Yes (Has a conflict 2 out of 10 times for the proposed extension),” “User B—Votes No (Has no conflicts),” “Conference Room B—Vote pending (Has a conflict 3 out of 10 times for the proposed extension)”, etc.).

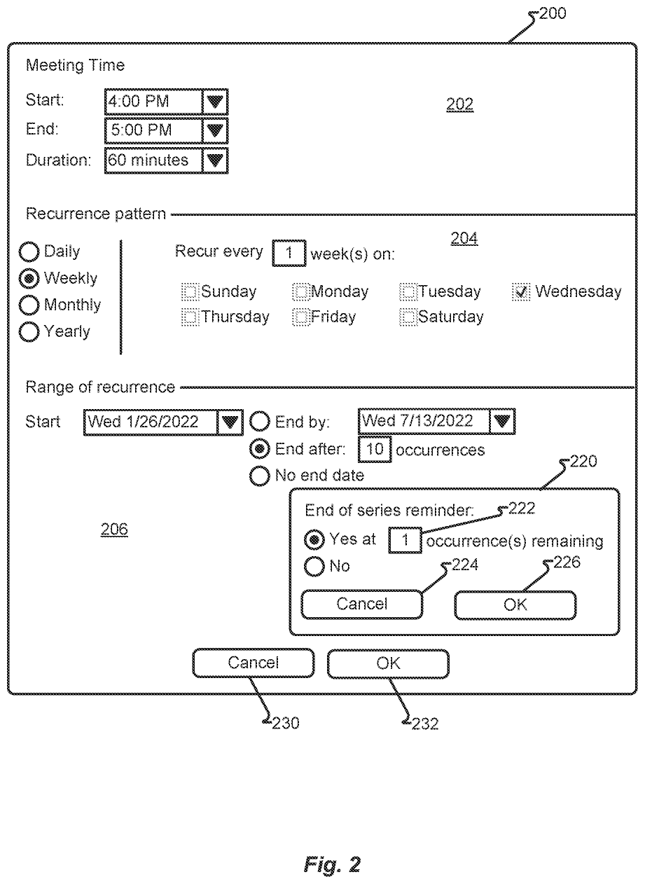

FIG. 2 depicts system generated graphical elements, such as scheduling dialog 200 in accordance with embodiments of the present disclosure. In one embodiment, scheduling dialog 200 is a representation of an output of a processor, such as a processor of user device 102 and/or calendar server 112, that schedules a new meeting as presented on a display, such as a display of user device 102. Scheduling dialog 200 comprises time block 202, recurrence block 204, range block 206, and reminder block 220 (which may be presented as a pop-up dialog). Time block 200 receives input of a selected time/duration of the meeting. Block 204 receives inputs of selected attributes of the recurrences of the meeting, such as weekly on Wednesdays (as illustrated). Block 206 receives inputs of the range of iterations, such as whether the meeting will repeat indefinitely, have a particular end date, or a set number of iterations.

For meetings having a finite number of iterations or a particular end date, dialog 220 may be triggered if not already presented. Dialog 220 prompts a user to activate a reminder and optionally input a set number of meetings remaining, in order to trigger the reminder in block 222. The user can then select cancel button 224 to discard changes or OK button 226 to save changes. Similarly, scheduling dialog 200 may be closed without saving changes by selecting cancel button 230, or save changes, and thereby create the meeting, by selecting OK button 232. It should be appreciated that “meeting” as used herein may, in other embodiments, refer to non-meeting events (e.g., “Prepare for upcoming weekly meeting.”). However, when other attendees or resources are invited to the meeting, selecting OK button 232 triggers the sending of an invitation to those persons/resources listed to be invited.

In another embodiment, an event creator sends invitees the invitation comprising an event reminder determined by the event creator. For example, a default reminder may be triggered for presentation to each invitee fifteen minutes before each iteration. However, an invitee may wish to have a different time, such as to allow for additional travel or preparation time and have their reminder be presented at a different time, for example, two hours before each iteration. Invitees may access their calendar on a number of different devices (e.g., mobile phone, desktop computer, etc.). If devices are client devices accessing a centralized calendar, then the reminder may be triggered based on querying the central calendar. If devices maintain a copy of the calendar, such as to work offline, then the calendars will need to be synchronized. When an event and/or reminder is created one calendar can be updated and a flag set indicating changes are present. When another devices periodically or on-demand checks the calendar, the flag will indicate an update is needed and the device's calendar updated accordingly.

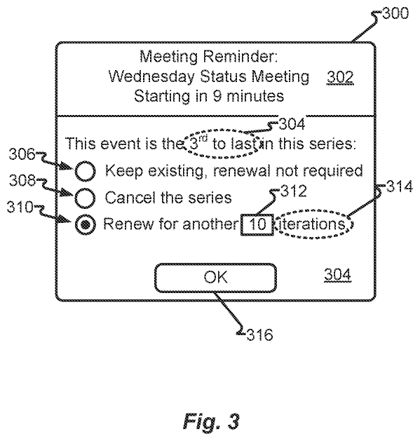

FIG. 3 depicts a system generated graphical element such as reminder dialog 300 in accordance with embodiments of the present disclosure. In one embodiment, reminder dialog 300 is a representation of an output of a processor, such as a processor of user device 102 and/or calendar server 112, to schedule a new meeting as presented on a display, such as a display of user device 102. In one embodiment, a triggering event has occurred and, in one embodiment, the triggering event is identified in combination with meeting reminder 302 for an upcoming iteration of the meeting.

Recurrence block 304 receives an input as to whether additional iterations of the meeting should be created and, if so, attributes of the additional iterations. Dynamic text 304 indicates how many meetings remain in the series when graphical element is presented. Inputs are solicited, such as option 306 to indicate the message should be left as-is and without adding any additional iterations, option 308 to cancel the series (which may further comprise an option to cancel the currently upcoming meeting or keep the currently upcoming meeting), and option 310 to renew for a number of iterations, which are provided in block 312 and dynamic text 314. In another embodiment, block 312 may be a date field and dynamic text 314 identifying the contents of block 312 as an ending date, for the additional embodiments. Upon selecting OK button 316, the meeting attributes are saved and if additional iterations are added, modifications are triggered to calendar database 114 and/or other calendaring databases to maintain the additional meeting iterations.

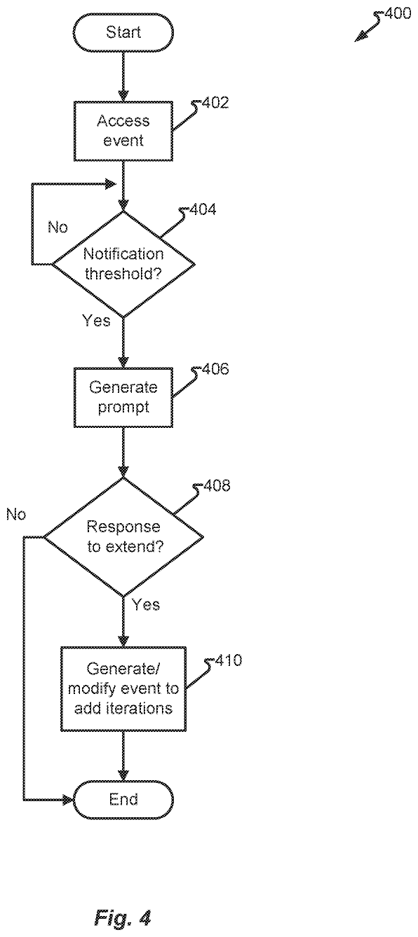

FIG. 4 depicts process 400 in accordance with embodiments of the present disclosure. In one embodiment, process 400 is embodied as machine-readable instructions maintained in a non-transitory data storage that, when read by a processor, such as a processor of calendar server 112 and/or user device 102, cause the processor to perform process 400.

Process 400 begins and, in step 402, an event is accessed, such as a record in calendar server 112, user device 102, other resource calendar database 112, and/or other calendaring event record data storage. The event may be a meeting or other activity (e.g., time allocated to study or prepare for another meeting). Test 404 determines if a notification threshold has been reached and, if determined in the negative, loops back to itself to be repeated with an optional delay to avoid unnecessary processor utilization. If test 404 is determined in the affirmative, processing continues to step 406 and a prompt is generated and sent, such as to a device of a user (e.g., user device 102 of user 104). Test 408 determines if a response to the prompt has been received indicating the event should be extended. If test 408 is determined in the negative, process 400 may end or loop back to step 402 to access another event. If step 408 is determined in the affirmative, processing continues to step 410 wherein a record in a calendaring database, such as calendar database 114, other resource calendar database 112, and/or locally in user device 102, is updated to either extend the number of iterations of the current event or add additional iterations matching the recurrence pattern of the event. After which, process 400 may end or loop back to step 402 to access another event.

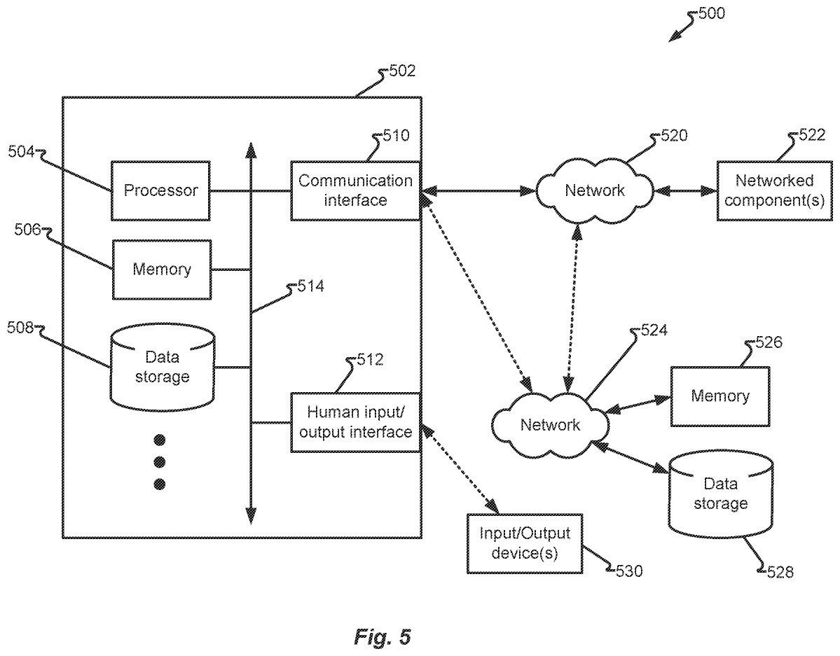

FIG. 5 depicts device 502 in system 500 in accordance with embodiments of the present disclosure. In one embodiment, calendar server 112 and/or user device 102 may be embodied, in whole or in part, as device 502 comprising various components and connections to other components and/or systems. The components are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, memory 506, data storage 508, etc., that cause the processor 504 to perform the steps of the instructions. Processor 504 may be further embodied as a single electronic microprocessor or multiprocessor device (e.g., multicore) having electrical circuitry therein, which may further comprise a control unit(s), input/output unit(s), arithmetic logic unit(s), register(s), primary memory, and/or other components, that accesses information (e.g., data, instructions, etc.), such as information received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize memory 506 and/or data storage 508 for the storage of accessible data, such as instructions, values, etc. Communication interface 510 facilitates communication with components, such as processor 504 via bus 514 with components not accessible via bus 514. Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or configured to utilize one or more networks, such as network 520 and/or network 524.

Communication link 110 may be embodied, in whole or in part, as network 520. Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.)

Additionally or alternatively, one or more other networks may be utilized. For example, network 524 may represent a second network, which may facilitate communication with components utilized by device 502. For example, network 524 may be an internal network to a business entity or other organization, whereby components are trusted (or at least more so) that networked components 522, which may be connected to network 520 comprising a public network (e.g., Internet) that may not be as trusted.

Components attached to network 524 may include memory 526, data storage 528, input/output device(s) 530, and/or other components that may be accessible to processor 504. For example, memory 526 and/or data storage 528 may supplement or supplant memory 506 and/or data storage 508 entirely or for a particular task or purpose. As another example, memory 526 and/or data storage 528 may be an external data repository (e.g., server farm, array, “cloud,” etc.) and enable device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of memory 506, data storage 508, memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, switch, port, or other communication component such that a particular output of processor 504 enables (or disables) input/output device 530, which may be associated with network 520 and/or network 524, to allow (or disallow) communications between two or more nodes on network 520 and/or network 524. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method of modifying a calendar event record, comprising:
accessing a calendaring database comprising a calendar and wherein the calendar comprises a record of an event and wherein the event comprising a series of recurring iterations of the event;
determining whether the event has reached a conclusion notification threshold;
upon determining that the event has reached the conclusion notification threshold, generating a prompt to extend the event with a number of additional iterations;
causing a user device to present the prompt and receive a response therefrom; and
when the response indicates extending the series, generating a meeting event to add the number of additional iterations to the event.

2. The method of claim 1, wherein the prompt is presented as a portion of a meeting reminder for at least one iteration of the event.

3. The method of claim 1, wherein generating the meeting event to add the number of additional iterations to the event further comprises adding the number of additional iterations to a plurality of calendars corresponding to resources of the event.

4. The method of claim 3, wherein generating the prompt further comprises generating a prompt to include indicia of availability of the resources of the event.

5. The method of claim 1, wherein determining whether the event has reached the conclusion notification threshold further comprises, performing the determining upon at the occurrence of, at least one of, a determined number of remaining iterations of the event remain or a determined time before the last recurring iteration of the event occurs.

6. The method of claim 1, wherein:
the response indicates extending the series, comprises an absence of any response within a previously determined period of time; and
the generating of the meeting event to add the number of additional iterations occurs automatically and without receiving any input to the prompt.

7. The method of claim 6, wherein the number of additional iterations are deleted upon receiving the response to the prompt indicating not to extend the series.

8. The method of claim 6, wherein the generating the meeting event further comprises generating a meeting attribute indicating that the additional iterations were automatically generated.

9. The method of claim 6, wherein the generating the meeting event further comprises generating a meeting attribute indicating that the additional iterations are tentative.

10. A system, comprising:
a database comprising calendar records for at least one user, the calendar record comprising an event and wherein the event comprising a series of recurring iterations of the event;
a processor configured with instructions maintained in a non-transitory memory, to cause the processor to perform:
accessing the calendaring database comprising the calendar;
determining whether the event has reached a conclusion notification threshold;
upon determining that the event has reached the conclusion notification threshold, generating a prompt to extend the event with a number of additional iterations;
causing a user device to present the prompt and receive a response therefrom; and
when the response indicates extending the series, generating a meeting event to add the number of additional iterations to the event.

11. The system of claim 10, wherein the prompt is presented as a portion of a meeting reminder for at least one iteration of the event.

12. The system of claim 10, wherein generating the meeting event to add the number of additional iterations to the event further comprises adding the number of additional iterations to a plurality of calendars corresponding to resources of the event.

13. The system of claim 12, wherein generating the prompt further comprises generating a prompt to include indicia of availability of the resources of the event.

14. The system of claim 10, wherein determining whether the event has reached the conclusion notification threshold further comprises, performing the determining upon at the occurrence of, at least one of, a determined number of remaining iterations of the event remain or a determined time before the last recurring iteration of the event occurs.

15. The system of claim 10, wherein:
the response indicates extending the series, comprises an absence of any response within a previously determined period of time; and
the generating of the meeting event to add the number of additional iterations occurs automatically and without receiving any input to the prompt.

16. The system of claim 15, wherein the number of additional iterations are deleted upon receiving the response to the prompt indicating not to extend the series.

17. The system of claim 15, wherein the generating the meeting event further comprises generating a meeting attribute indicating that the additional iterations were automatically generated.

18. The system of claim 15, wherein the generating the meeting event further comprises generating a meeting attribute indicating that the additional iterations are tentative.

19. A system, comprising:
means to access a calendaring database comprising a calendar and wherein the calendar comprises a record of an event and wherein the event comprising a series of recurring iterations of the event;
means to determine whether the event has reached a conclusion notification threshold;
means to, upon determining that the event has reached the conclusion notification threshold, generate a prompt to extend the event with a number of additional iterations;
means to cause a user device to present the prompt and receive a response therefrom; and
means to, when the response indicates extending the series, generate a meeting event to add the number of additional iterations to the event.

20. The system of claim 19, wherein:
the response indicates extending the series, comprises an absence of any response within a previously determined period of time; and
the means to generate of the meeting event to add the number of additional iterations further comprises means to generate the meeting event automatically and without receiving any input to the prompt
the means to generate the meeting event further comprises means to generate a meeting attribute indicating that the additional iterations were automatically generated.
